(19) United States
(12) Patent Application Publication
(10) Pub. No.: US 2015/0202099 A1
(43) Pub. Date: Jul. 23, 2015

(54) LIGHT WEIGHT MULTI USE COLLAPSIBLE STRETCHER

(71) Applicant: TELESTRETCH LTD, Yavne (IL)

(72) Inventors: Dan Sion, Yavne (IL); Alazar C. Yinbal, Encino, CA (US)

(21) Appl. No.: 14/409,113

(22) PCT Filed: Jun. 18, 2013
(86) PCT No.: PCT/IL2013/050523

§ 371 Date: Dec. 18, 2014

Related U.S. Application Data
(60) Provisional application No. 61/662,395, filed on Jun. 21, 2012.

(51) Int. Cl. A61G 1/013; A61G 1/02; A61G 1/007; A61G 1/044

(52) U.S. Cl. CPC A61G 1/013; A61G 1/044; A61G 1/0293; A61G 1/007

(57) ABSTRACT

A new light multi-use collapsible stretcher for carrying load comprising: two opposing longitudinal frames, each comprising at least four frame plates; at least one bedding member, disposed between the longitudinal frames; plurality of hinges; and at least one foldable and reversibly lockable supporting bar, disposed between the two opposing longitudinal frames and pivotally connected to the two longitudinal frames by the hinges; the frame plates are pivotally connected to each other by the hinges in a series configuration; the hinges disposed between the frame plates in alternate rotation directions, such that the frame plates and the bedding member configured for a reversible operation of unfolding and folding of the stretcher into an unfolded and folded position.

### BACKGROUND OF THE INVENTION

Stretchers are emergency evacuation devices used to carry casualties or an incapacitated people evacuate and convey them from one place to another. A stretcher is usually carried by two people or more, at the head and at the feet of the incapacitated person. The casualty is placed on the stretcher, and can then be carried or wheeled away. Stretchers are indicated if a person is either unable to walk or walking by him/herself may compromise his/her health, or if other requirements such as a wheelchair, or similar device cannot be used.

It has been well established that a stretcher needs to be lightweight, strong enough, durable and foldable, as well as very quickly and easily erectable. It is a further requirement that stretcher would be transformable and modified for multi uses needed such as: ladder, bridge, electronic device carrier, airlift, wheeled carriage and other similar devices. To meet this need, stretchers having multiple fold lines have been developed. Such stretchers are readily transported in its folded state, and are sufficiently compact to allow a medic or any rescue crewmember to carry a folded stretcher by hand or on the back.

Zalman U.S. Pat. No. 4,685,161 discloses a foldable framework for objects such as: stretchers, beds, bridges and the like. The framework comprises first and second carrier rod assemblies linked to each other by foldable connecting means, each such assembly comprising four rods linked by three joints, a central joint and two peripheral joints so designed that the extreme rods of the two carrier rod assemblies swing in different planes.

Guo CN2305977 discloses an M-shaped four-section and three-fold portable stretcher for the field of the rescue and the life saving. The weight of the stretcher is about 4 kilograms and is suitable for one person walking and carrying, and can also be arranged in a micro-miniature motor vehicle to carry.

Chaojun CN201572259U discloses a dual-use portable folding stretcher mainly comprises two supporting rods and a supporting surface, wherein the two supporting rods pass through the two long sides of the rectangular supporting surface and adopt the structures formed in the manner that two sections of insertion pipes are connected and fixed in a mutually-inserted manner; a layer of air-filled mattress are arranged below the supporting surface; rolling wheels are installed at the corners of the bottom surface of the air-filled mattress; and the surface corners of the supporting surface are respectively connected with bandages. The dual-use portable folding stretcher has the advantages of reasonable structure, convenience, practicability, flexible operation and the like.

Sion and Yinbal WO2010131247 disclosed in a former document a foldable stretcher for transporting an object, comprising: a plurality of substantially plane members pivotally connected with each other in series by means of hinges there between; handles pivotally connected to outermost of the plane members; and, at least two pluralities of props. The stretcher further comprises at least two pairs of sufficiently stiff wires. Each pair of the wires arranged along a corresponding long side of the stretcher; each the wire is mechanically connected to the stretcher at least two connection points.

An improved stretcher of a more convenient structure is a long felt unmet need.

### SUMMARY OF THE INVENTION

It is one object of the present invention to provide a lightweight multi-use collapsible stretcher [100] for carrying load, comprising:
a) two opposing longitudinal frames [110], each comprising at least four frame plates [120];
b) at least one bedding member [130], disposed between the longitudinal frames [110];
c) plurality of hinges [140]; and
d) at least one foldable and reversibly fastenable supporting bar [210], disposed between the two opposing longitudinal frames [110] and pivotally connected to the two longitudinal frames [110] by the hinges [140];

wherein the frame plates [120] are pivotally connected to each other by the hinges [140] in a series configuration; the hinges [140] disposed between the frame plates [120] in alternate rotation directions, such that the frame plates [120] and the bedding member [130] configured for a reversible operation of unfolding and folding of the stretcher [100] into an unfolded and folded position.

It is another object of the present invention to provide the lightweight multi-use collapsible stretcher [100] mentioned above, wherein the frame plates [120] configured as beams with a rectangular- or an I-shape-cross section, such that the frame plates [120] effectively bear the load and resist bending.

It is another object of the present invention to provide the lightweight multi-use collapsible stretcher [100] mentioned above, wherein the at least one supporting bar [210] is adapted to firmly fix the two longitudinal frames [110], such that the two longitudinal frames [110] are parallel to each other and perpendicular to the bedding member [130], in the unfolded position.

It is another object of the present invention to provide the lightweight multi-use collapsible stretcher [100] mentioned above, wherein the at least one supporting bar [210] configured to be reversibly detached from one of the longitudinal frames [110] and be attached to the other the longitudinal frames [110], in the folded position.

It is another object of the present invention to provide the lightweight multi-use collapsible stretcher [100] mentioned above, wherein the at least one supporting bar [210] comprises two reversibly separable sections [310] configured for reversible attachment and detachment; each of the sections [310] further configured to be attached to the corresponding the longitudinal frame [110], in the folded position.

It is another object of the present invention to provide the lightweight multi-use collapsible stretcher [100] mentioned above, wherein the external ends of the external the frame plates [120] comprise grip-handles [150].

It is another object of the present invention to provide the lightweight multi-use collapsible stretcher [100] mentioned above, wherein the grip-handles [150] are covered with a comfortable ergonomic material selected from a group consisting of: rubber, silicon, foam, plastic, composite material and any combination thereof.

It is another object of the present invention to provide the lightweight multi-use collapsible stretcher [100] mentioned above, wherein the grip-handles [150] are foldable or telescopically shortened.

It is another object of the present invention to provide the lightweight multi-use collapsible stretcher [100] mentioned above, wherein the frame plates [120] are fenestrated for the attachment of additional accessories.

It is another object of the present invention to provide the lightweight multi-use collapsible stretcher [100] mentioned above, wherein at least one of the plurality of hinges [140] is a dual axis rotating hinge.

It is another object of the present invention to provide the lightweight multi-use collapsible stretcher [100] mentioned above, wherein at least one of the hinges [140] is a double action hinge.

It is another object of the present invention to provide the lightweight multi-use collapsible stretcher [100] mentioned above, wherein the bedding member [130] comprises of at least one fabric strap or mesh.

It is another object of the present invention to provide the lightweight multi-use collapsible stretcher [100] mentioned above, wherein the bedding member [130] is configured for reversible removal from the two opposing longitudinal frames [110].

It is another object of the present invention to provide the lightweight multi-use collapsible stretcher [100] mentioned above, wherein the bedding member [130] comprises at least four rigid platform members [610].

It is another object of the present invention to provide the lightweight multi-use collapsible stretcher [100] mentioned above, wherein the platform members [610] are fenestrated for the attachment of additional accessories.

It is another object of the present invention to provide the lightweight multi-use collapsible stretcher [100] mentioned above, wherein the platform members [610] are connected to the longitudinal frame [110] by flexible connectors [620] or by the hinges [140], configured to allow the longitudinal frame [110] to be rotated towards and away from the platform members [610].

It is another object of the present invention to provide the lightweight multi-use collapsible stretcher [100] mentioned above, wherein the number of the platform members [610] is same as the number of the frame plates [120].

It is another object of the present invention to provide the lightweight multi-use collapsible stretcher [100] mentioned above, wherein the platform members [610] are made of a material selected from the group consisting of: metal, polymeric material, composite material, wood and any combination thereof.

It is another object of the present invention to provide the lightweight multi-use collapsible stretcher [100] mentioned above, wherein the platform members [610] have a shape selected from a group consisting of a grate-like, a honeycomb-like, a perforated shape and any combination thereof.

It is another object of the present invention to provide the lightweight multi-use collapsible stretcher [100] mentioned above, wherein the stretcher [100] is configured to be used as a footbridge or a ladder pallet.

It is another object of the present invention to provide the lightweight multi-use collapsible stretcher [100] mentioned above, wherein the stretcher [100] in the folded position is configured to be transported on- and by-a user, in a vehicle's compartment and/or for storage.

It is another object of the present invention to provide the lightweight multi-use collapsible stretcher [100] mentioned above, wherein the stretcher [100] further comprises of back splint or straps, for securing the load to the stretcher [100].

It is another object of the present invention to provide the lightweight multi-use collapsible stretcher [100] mentioned above, wherein the load is selected from a group consisting of: a patient, an individual of limited capability, an disabled person, an injured person, a victim of an emergency situation, an animal, an unanimated object and any combination thereof.

It is another object of the present invention to provide the lightweight multi-use collapsible stretcher [100] mentioned above, wherein the frame plates [120] are made of a material selected from a group consisting of: metal, polymeric material, composite material, wood and any combination thereof.

It is another object of the present invention to provide the lightweight multi-use collapsible stretcher [100] mentioned above, wherein the stretcher [100] is configured to be used as a bed.

It is another object of the present invention to provide the lightweight multi-use collapsible stretcher [100] mentioned above, wherein the stretcher [100] weighs less than 4 Kg.

It is another object of the present invention to provide the lightweight multi-use collapsible stretcher [100] mentioned above, wherein the stretcher [100] is further configured to be attached to an item selected from a group consisting of: wheels, at least one sled, emergency medical intervene means and any combination thereof.

It is another object of the present invention to provide the lightweight multi-use collapsible stretcher [100] mentioned above, wherein the stretcher [100] further comprises connectors for attaching at least two of the stretchers [100] in parallel- or in sequential-series configuration.

It is another object of the present invention to provide the lightweight multi-use collapsible stretcher [100] mentioned above, wherein the stretcher [100] further comprises connectors for attaching electric and electronic equipment.

It is another object of the present invention to provide the lightweight multi-use collapsible stretcher [100] mentioned above, wherein the stretcher [100] further comprises connectors for attaching carrying extension cables or ropes.

It is another object of the present invention to provide the lightweight multi-use collapsible stretcher [100] mentioned above, wherein the stretcher [100] further comprises fixation elements configured to fix the load to the stretcher [100] by means of tying.

It is another object of the present invention to provide the lightweight multi-use collapsible stretcher [100] mentioned above, wherein the stretcher [100] is made of material at least partially transparent to X-rays and electro-magnetic fields.

It is another object of the present invention to provide the lightweight multi-use collapsible stretcher [100] mentioned above, wherein the stretcher [100] further comprises a live saving kit [630].

It is another object of the present invention to provide the lightweight multi-use collapsible stretcher [100] mentioned above, wherein the live saving kit [630] comprises an item selected from a group consisting of: tourniquet means, needles, sutures, bandages, vital monitoring devices, intravenous therapy means, telescopic rod for fixating intravenous means, endotracheal-tube, tracheostomy means and any combination thereof.

It is another object of the present invention to provide the lightweight multi-use collapsible stretcher [100] mentioned above, wherein the stretcher further comprises a transmitter [640] for transmitting a patient's vitals and status.

It is another object of the present invention to provide a method for using a lightweight multi-use collapsible stretcher [100] for carrying load, comprising steps of:
a) providing a lightweight multi-use collapsible stretcher [100] comprising of:
   i. two opposing longitudinal frames [110], each comprising of at least four frame plates [120];
   ii. at least one bedding member [130], disposed between the two opposing longitudinal frames [110];
   iii. plurality of hinges [140]; and
   iv. at least one foldable and reversibly fastenable supporting bar [210]; the supporting bar [210] disposed between the two opposing longitudinal frames [110] and pivotally connected to the two opposing longitudinal frames [110] by the hinges [140];
wherein the frame plates [120] are pivotally connected to each other by the hinges [140] in a series configuration; the hinges [140] disposed between the frame plates [120] in alternate rotation directions, thereby the frame plates [120] and the bedding member [130] configured for a reversible operation of unfolding and folding of the stretcher [100] into an unfolded and folded position;
b) unfolding the stretcher [100] into an operative the unfolded position; and
c) folding the stretcher [100] into the folded position.

It is another object of the present invention to provide the method mentioned above, wherein the folding comprising steps of:
a) unfastening the at least one supporting bar [210];
b) attaching the supporting bar [210] to the longitudinal frames [110];
c) rotating the two longitudinal frames [110], thereby laying the two longitudinal frames [110] in a close proximity to one another; and
d) folding the bedding member [130] together with its attached the frame plates [120].

It is another object of the present invention to provide the method mentioned above, wherein the unfolding comprising of steps of:
a) unfolding the frame plates [120], thereby forming the two longitudinal frames [110];
b) rotating the two longitudinal frames [110], thereby fixing the two longitudinal frames [110] parallel to one another;
c) detaching the at least one supporting bar [210] from the longitudinal frames [110];
d) fastening the and locking the supporting bar [210].

It is another object of the present invention to provide the method mentioned above, further comprising at least one of the following steps of:
a) fastening and locking the at least one supporting bar [210];
b) placing the load on the stretcher [100];
c) securing the load to the stretcher [100];
d) transporting the stretcher [100] to a designated location, while carrying the load; and
e) unloading the load from the stretcher [100].

It is another object of the present invention to provide the method mentioned above, wherein the frame plates [120] configured as beams with a rectangular- or an I-shape-cross section, thereby the frame plates [120] bear the load and resist bending.

It is another object of the present invention to provide the method mentioned above, wherein the at least one supporting bar [210] is adapted to firmly fix the two longitudinal frames [110], such that the two longitudinal frames [110] are parallel to each other and perpendicular to the bedding member [130], in the unfolded position.

It is another object of the present invention to provide the method mentioned above, wherein the at least one supporting bar [210] configured to be reversibly detached from one of the longitudinal frames [110] and be attached to the other the longitudinal frames [110], in the folded position.

It is another object of the present invention to provide the method mentioned above, wherein the at least one supporting bar [210] comprises two reversibly separatable sections [310] configured for reversible attachment and detachment; each of the sections [310] further configured to be attached to the corresponding the longitudinal frame [110], in the folded position.

It is another object of the present invention to provide the method mentioned above, wherein the external ends of the external the frame plates [120] comprise grip-handles [150].

It is another object of the present invention to provide the method mentioned above, wherein the grip-handles [150] are covered with a comfortable ergonomic material selected from a group consisting of: rubber, silicon, foam, plastic, composite material and any combination thereof.

It is another object of the present invention to provide the method mentioned above, wherein the grip-handles [150] are foldable or telescopically shortened.

It is another object of the present invention to provide the method mentioned above, wherein the frame plates [120] are fenestrated for the attachment of additional accessories.

It is another object of the present invention to provide the method mentioned above, wherein at least one of the plurality hinges [140] is a dual axis rotating hinge.

It is another object of the present invention to provide the method mentioned above, wherein at least one of the hinges [140] is a double action hinge.

It is another object of the present invention to provide the method mentioned above, wherein the bedding member [130] comprises of at least one fabric strap or mesh.

It is another object of the present invention to provide the method mentioned above, wherein the bedding member [130] is configured for reversible removal from the two opposing longitudinal frames [110].

It is another object of the present invention to provide the method mentioned above, wherein the bedding member [130] comprises as at least four rigid platform members [610].

It is another object of the present invention to provide the method mentioned above, wherein the platform members [610] are fenestrated for the attachment of additional accessories.

It is another object of the present invention to provide the method mentioned above, wherein the platform members [610] are connected to the longitudinal frame [110] by flexible connectors [620] or by the hinges [140], configured to allow the longitudinal frame [110] to be rotated towards and away from the platform members [610].

It is another object of the present invention to provide the method mentioned above, wherein the number of the platform members [610] is same as the number of the frame plates [120].

It is another object of the present invention to provide the method mentioned above, wherein the platform members [610] are made of a material selected from the group consisting of: metal, polymeric material, composite material, wood and any combination thereof.

It is another object of the present invention to provide the method mentioned above, wherein the platform members [610] have a shape selected from a group consisting of a grate-like, a honeycomb-like, a perforated shape and any combination thereof.

It is another object of the present invention to provide the method mentioned above, wherein the stretcher [100] is configured to be used as a footbridge or a ladder pallet.

It is another object of the present invention to provide the method mentioned above, wherein the stretcher [100] in the folded position is configured to be transported on- and by-a user, in a vehicle's compartment and/or for storage.

It is another object of the present invention to provide the method mentioned above, wherein the stretcher [100] further comprises of back splint or straps, for securing the load to the stretcher [100].

It is another object of the present invention to provide the method mentioned above, wherein the load is selected from a group consisting of: a patient, an individual of limited capability, an disabled person, an injured person, a victim of an emergency situation, an animal, an unanimated object and any combination thereof.

It is another object of the present invention to provide the method mentioned above, wherein the frame plates [120] are made of a material selected from a group consisting of: metal, polymeric material, composite material, wood and any combination thereof.

It is another object of the present invention to provide the method mentioned above, wherein the stretcher [100] is configured to be used as a bed.

It is another object of the present invention to provide the method mentioned above, wherein the stretcher [100] weighs less than 4 Kg.

It is another object of the present invention to provide the method mentioned above, wherein the stretcher [100] is further configured to be attached to an item selected from a group consisting of: wheels, at least one sled, emergency medical intervene means and any combination thereof.

It is another object of the present invention to provide the method mentioned above, wherein the stretcher [100] further comprises connectors for attaching at least two of the stretchers [100] in parallel- or in sequential-series configuration.

It is another object of the present invention to provide the method mentioned above, wherein the stretcher [100] further comprises connectors for attaching electric and electronic equipment.

It is another object of the present invention to provide the method mentioned above, wherein the stretcher [100] further comprises connectors for attaching carrying extension cables or ropes.

It still an object of the present invention to provide the method mentioned above, wherein the stretcher [100] further comprises fixation elements configured to fix the load to the stretcher [100] by means of tying.

It lastly an object of the present invention to provide the method mentioned above, wherein the stretcher [100] is made of material at least partially transparent to X-rays and electro-magnetic fields.

It is another object of the present invention to provide the method mentioned above, wherein the stretcher [100] further comprises a live saving kit [630].

It is still an object of the present invention to provide the method mentioned above, wherein the live saving kit [630] comprises an item selected from a group consisting of: tourniquet means, needles, sutures, bandages, vital monitoring devices, intravenous therapy means, telescopic rod for fixating intravenous means, endotracheal-tube, tracheostomy means and any combination thereof.

It lastly an object of the present invention to provide the method mentioned above, wherein the stretcher further comprises a transmitter [640] for transmitting a patient's vitals and status.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 presents an illustrated view of the light multi-use stretcher [100] in an unfolded position;

FIG. 2 presents an illustrated upside-down view of the light multi-use stretcher [100] in an unfolded position;

FIG. 3 presents an illustrated view of the light multi-use stretcher [100] in a partially folded position;

FIG. 4 presents another illustrated view of the light multi-use stretcher [100] in a partially folded position;

FIG. 5 presents an illustrated another view of the light multi-use stretcher [100] in a folded position;

FIG. 6 presents an illustrated view of the light multi-use stretcher [100] where the bedding member [130] comprises at least four rigid platform members [610]; and

FIG. 7 presents an illustrated upside-down view of the light multi-use stretcher [100] where the bedding member [130] comprises at least four rigid platform members [610].

### DETAILED DESCRIPTION OF PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a novel and useful stretcher device and methods.

The present invention is a new light multi-use collapsible stretcher for carrying load. In particular, the invention is specially suited for the purpose of, but not limited to, carrying wounded humans, animals or equipment including electrical equipment. Also the new light multi-use stretcher is suited for a usage as a bed, bridge or a ladder.

The new lightweight multi-use collapsible stretcher [100] comprises:
a) two opposing longitudinal frames [110], each comprising at least four frame plates [120];
b) at least one bedding member [130], disposed between the longitudinal frames [110];
c) plurality of hinges [140]; and
d) at least one foldable and reversibly fastenable supporting bar [210], disposed between the two opposing longitudinal frames [110] and pivotally connected to the two opposing longitudinal frames [110] by the hinges [140];

The frame plates [120] are pivotally connected to each other by the hinges [140] in a series configuration; the hinges [140] disposed between the frame plates [120] in alternate rotation directions, such that the frame plates [120] and the bedding member [130] configured for a reversible operation of unfolding and folding of the stretcher [100] into an unfolded and folded position.

In one embodiment of the present invention the at least one supporting bar [210] is configured to be detached from one of the opposing longitudinal frames [110] and to be attached to the other opposing longitudinal frame [110], for the purpose of folding the stretcher [100].

In another embodiment the at least one supporting bar [210] is comprises two reversibly separatable sections [310]; each of the sections [310] configured to be separated from the other and to be attached to the corresponding longitudinal frame [110] (the one it is hinged to), for the purpose of folding the stretcher [100].

The present invention further discloses a method useful for the operation of the new lightweight multi-use collapsible stretcher [100] which comprising steps of:
a) providing the lightweight multi-use collapsible stretcher [100], comprising of:
   i. two opposing longitudinal frames [110], each comprising of at least four frame plates [120];
   ii. at least one bedding member [130], disposed between the two opposing longitudinal frames [110];
   iii. plurality of hinges [140]; and
   iv. at least one foldable and reversibly fastenable supporting bar [210]; the supporting bar [210] disposed between the two opposing longitudinal frames [110] and pivotally connected to the two opposing longitudinal frames [110] by the hinges [140];
the frame plates [120] are pivotally connected to each other by the hinges [140] in a series configuration; the hinges [140] disposed between the frame plates [120] in alternate rotation directions, thereby the frame plates [120] and the bedding member [130] configured for a reversible operation of unfolding and folding of the stretcher [100] into an unfolded and folded position;
b) unfolding the stretcher [100] into an operative unfolded position; and
c) folding the stretcher [100] into the folded position.

In a preferred embodiment the method mentioned above further comprising steps of:
a) unfastening the at least one supporting bar [210];
b) attaching the supporting bar [210] to the longitudinal frames [110];
c) rotating the two longitudinal frames [110], thereby laying the two longitudinal frames [110] in a close proximity to one another; and
d) folding the bedding member [130] together with its attached the frame plates [120].

In another preferred embodiment the method mentioned above further comprising steps of:
a) unfolding the frame plates [120], thereby forming the two longitudinal frames [110];
b) rotating the two longitudinal frames [110], thereby fixing the two longitudinal frames [110] parallel to one another;
c) detaching the at least one supporting bar [210] from the longitudinal frames [110];
d) fastening the and locking the supporting bar [210].

In another embodiment the method mentioned above further comprising at least one of the following steps of:
a) fastening and locking the at least one supporting bar [210];
b) placing the load on the stretcher [100];
c) securing the load to the stretcher [100];
d) transporting the stretcher [100] to a designated location, while carrying the load; and
e) unloading the load from the stretcher [100].

In another preferred embodiment the two longitudinal frames [110] are configured as a beam with a rectangular or an I-shape cross-section, for bearing the loads force vectors.

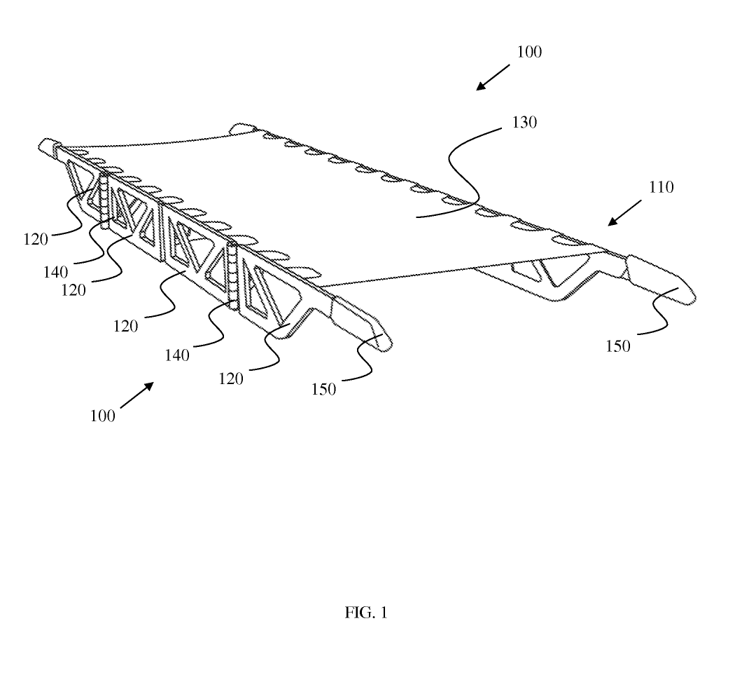

Reference is now made to FIG. 1, which presents an illustrated view of the lightweight multi-use stretcher [100] in an unfolded position. In this demonstration, the two opposing longitudinal frames [110] comprise four rectangular frame plates [120]. The frame plates [120] are connected to each other in a series configuration by hinges [140]; the hinges [140] disposed therebetween in alternate rotation directions, thereby forming the two opposing longitudinal frames [110]. The two opposing longitudinal frames [110] are used as the foundation frame for all stretcher [100] parts and for elevating the stretcher [100] above ground.

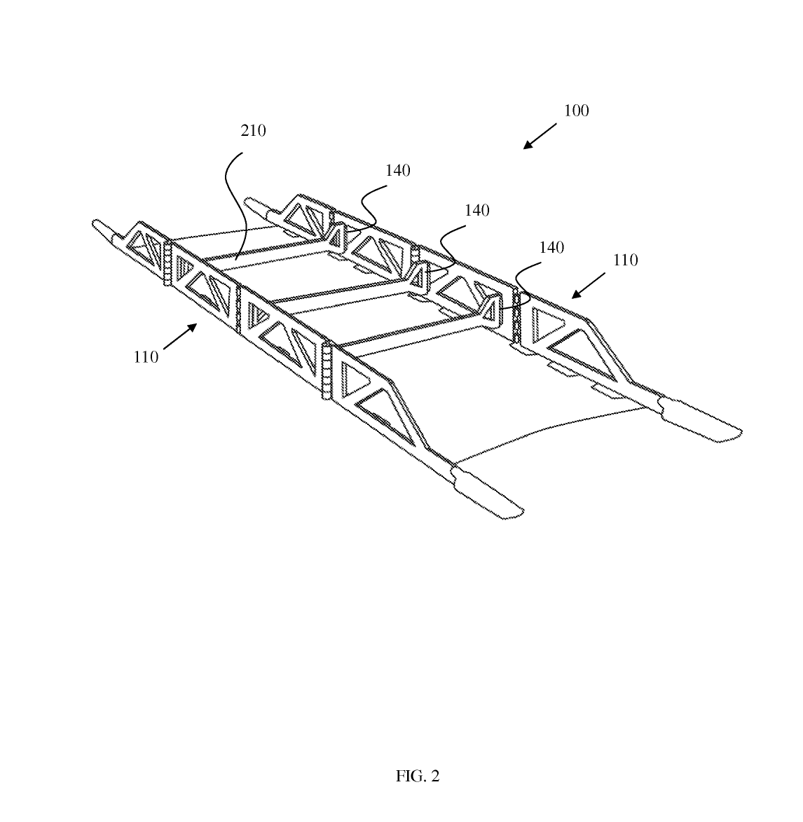

In one embodiment the stretcher's bedding member [130] is a flexible fabric bedding, as demonstrated in FIGS. 1 and 2, allowing the folding and unfolding of the stretcher [100].

It is further demonstrated in FIG. 1 that the two external frame plates [120] of each of the opposing longitudinal frames [110] comprise of a grip-handle [150], at their external end.

It is further demonstrated in FIG. 1 that the two external platform members [120] are shorter than the central platform members [120], in order to allow the configuration of the grip-handle [150], at the external ends of the stretcher [100].

Reference is now made to FIG. 2, which presents an illustrated upside-down view of the light multi-use stretcher [100] in an unfolded position, demonstrating three supporting bars [210], adapted to fix the two opposing longitudinal frames [110] so that the opposing longitudinal frames [110] remain parallel to one another and perpendicular to the bedding member [130], in the unfolded position.

The supporting bar's hinges [140] are used for the rotation of the supporting bars [210] towards and away from the opposing longitudinal frames [110], for folding and unfolding the stretcher [100], and can be replaced by dual rotation axis hinges.

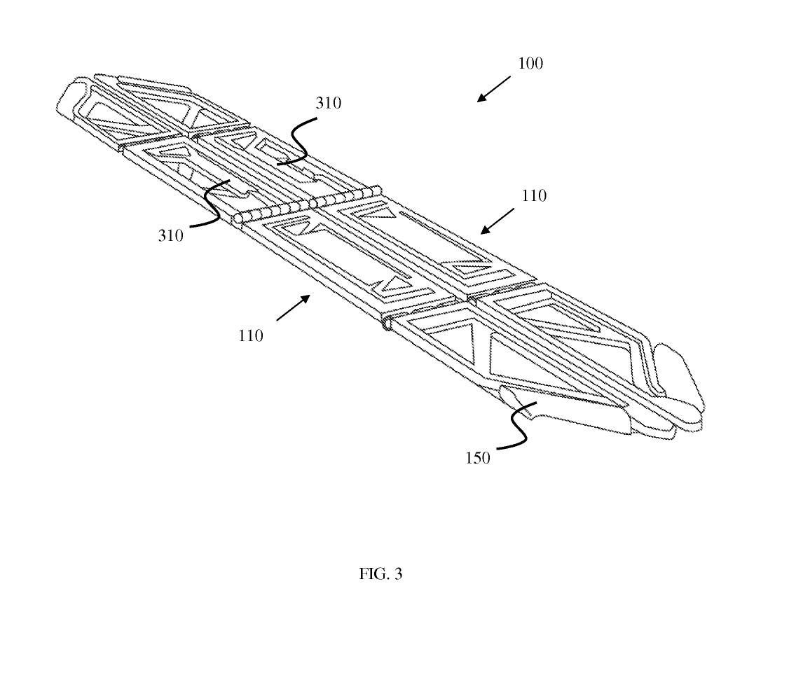

Reference is now made to FIG. 3, which presents an illustrated view of the light multi-use stretcher [100] in a partially folded position. FIG. 3 demonstrates the supporting bar [210] in an unfastened where the two sections [310] are separated and attached to their corresponding longitudinal frame [110]. FIG. 3 further demonstrates the initial folding stage, where the two opposing longitudinal frames [110] are folded towards each other forming a flat structure. FIG. 3 further demonstrates the grip handles [150] folded towards the external frame plates [120].

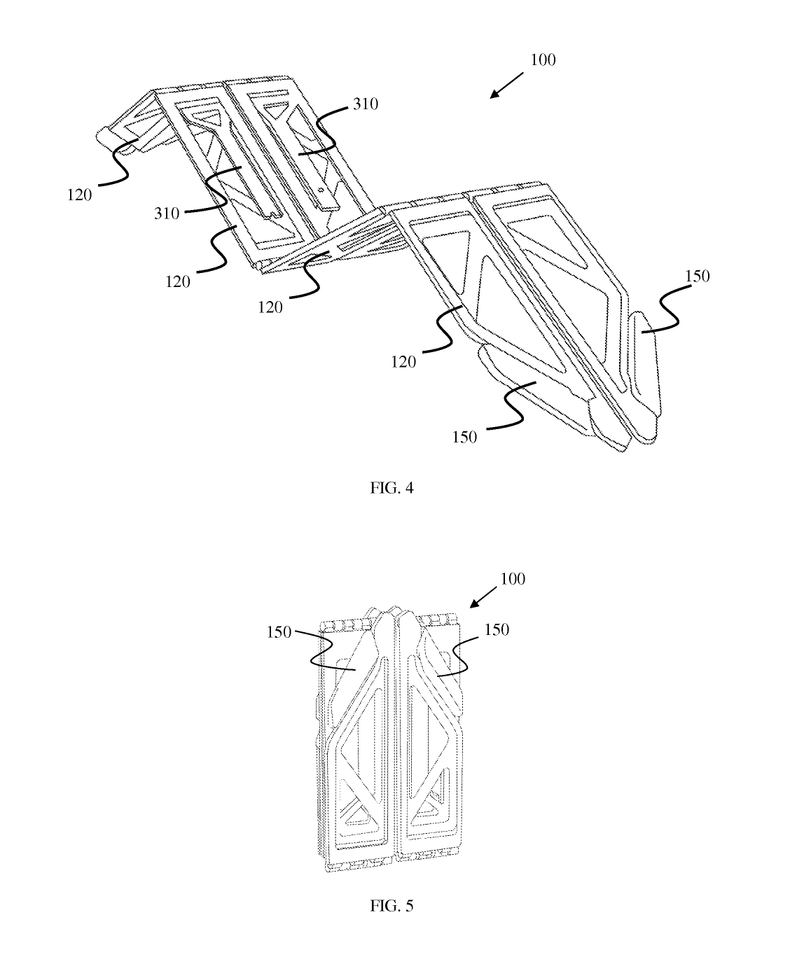

Reference is now made to FIG. 4, which presents another illustrated view of the light multi-use stretcher [100] in a partially folded position. FIG. 3 further demonstrates a following folding stage, where the frame plates [120] are rotated in alternate directions towards each other. FIG. 4 further demonstrates an example where the bedding member [130] is removed from the two opposing longitudinal frames [110].

Reference is now made to FIG. 5, which presents another illustrated view of the light multi-use stretcher [100] in a fully folded position, configured and suitable for transporting on a user's back, in a vehicle's compartment or for effective storage.

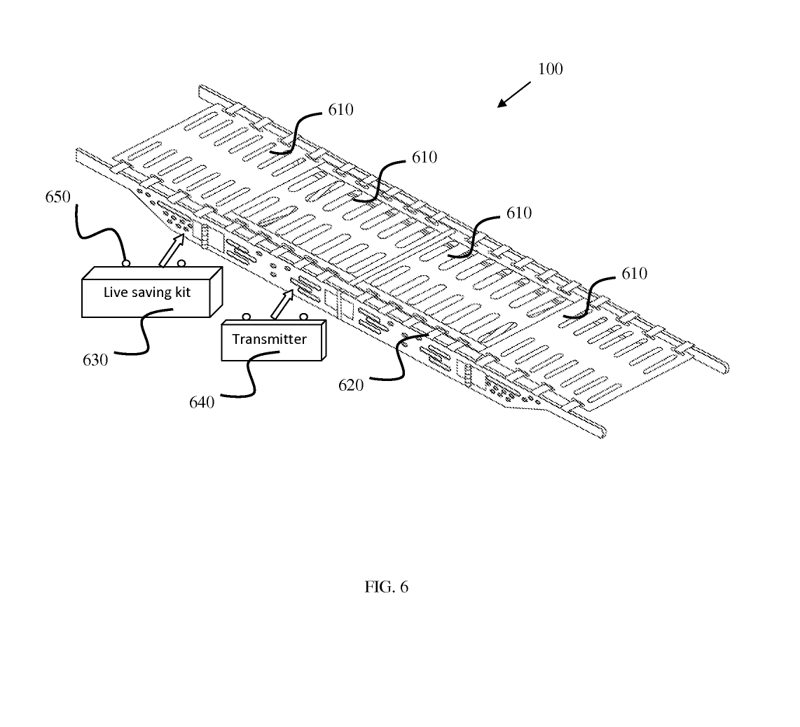

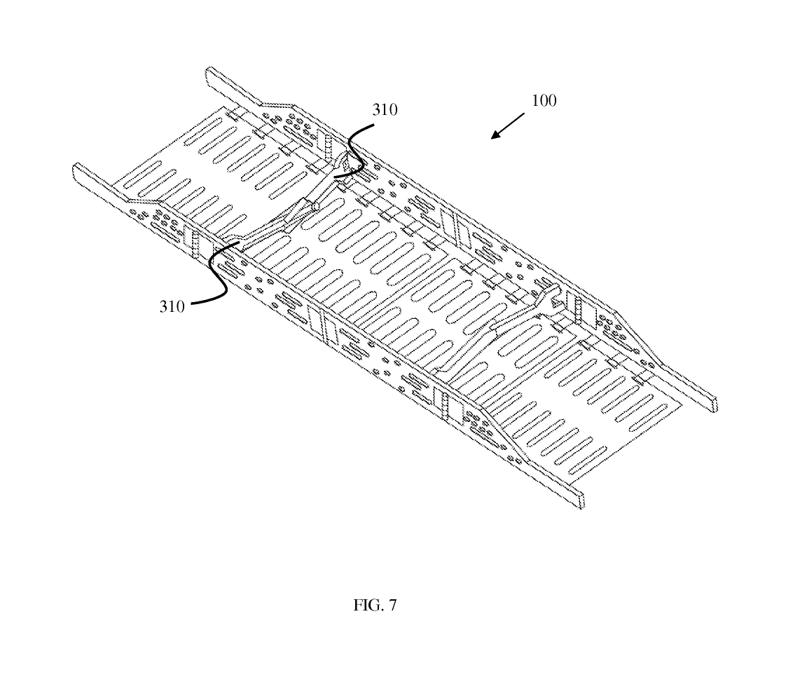

Reference is now made to FIGS. 6 and 7, which demonstrate the stretcher's bedding member [130] constructed of four rigid platform members [610]. The platform members [610] attached to the four frame plates [120], by means of plurality of flexible connectors [620] or hinges [140] (not shown), allowing the two opposing longitudinal frames [110] to be rotated towards and away from the platform members [610].

FIG. 6 further demonstrates another embodiment of the invention where the collapsible stretcher [100] further comprises a live saving kit [630], connected by connectors [650] to the body of the stretcher [100]. The live saving kit [630] can include items such as: tourniquet means, needles, sutures, bandages, vital monitoring devices, intravenous therapy means, telescopic rod for fixating intravenous means, endotracheal-tube, tracheostomy means and any combination thereof. In another embodiment the collapsible stretcher [100] may further include a transmitter [640] for transmitting the patient's vitals and status to the acting physician and/or to the receiving medical center.

It will be appreciated by a person skilled in the art that the present invention is not limited by what has been particularly shown and described hereinabove. Rather the scope of the present invention includes both combinations and sub-combinations of the features described hereinabove as well as modifications and variations thereof which would occur to a person of skill in the art upon reading the foregoing description and which are not in the prior art.

1. A lightweight multi-use collapsible stretcher [100] for carrying load, comprising:
a) two opposing longitudinal frames [110], each comprising at least four frame plates [120];
b) at least one bedding member [130], disposed between said longitudinal frames [110];
c) plurality of hinges [140]; and
d) at least one foldable and reversibly fastenable supporting bar [210], disposed between said two opposing longitudinal frames [110] and pivotally connected to said two longitudinal frames [110] by said hinges [140];
wherein said frame plates [120] are pivotally connected to each other by said hinges [140] in a series configuration; said hinges [140] disposed between said frame plates [120] in alternate rotation directions, such that said frame plates [120] and said bedding member [130] configured for a reversible operation of unfolding and folding of said stretcher [100] into an unfolded and folded position.

2. The collapsible stretcher [100] according to claim 1, wherein at least one of the following is true:
a. said frame plates [120] configured as beams with a rectangular- or an I-shape-cross section, such that said frame plates [120] effectively bear said load and resist bending;
b. said at least one supporting bar [210] is adapted to firmly fix said two longitudinal frames [110], such that said two longitudinal frames [110] are parallel to each other and perpendicular to said bedding member [130], in said unfolded position;
c. said at least one supporting bar [210] configured to be reversibly detached from one of said longitudinal frames [110] and be attached to the other said longitudinal frames [110], in said folded position;
d. said at least one supporting bar [210] comprises two reversibly separatable sections [310] configured for reversible attachment and detachment; each of said sections [310] further configured to be attached to the corresponding said longitudinal frame [110], in said folded position;
e. the external ends of the external said frame plates [120] comprise grip-handles [150].

3. The collapsible stretcher [100] according to claim 2, wherein said grip-handles [150] are covered with a comfortable ergonomic material selected from a group consisting of: rubber, silicon, foam, plastic, composite material and any combination thereof.

4. The collapsible stretcher [100] according to claim 2, wherein said grip-handles [150] are foldable or telescopically shortened.

5. The collapsible stretcher [100] according to claim 1, wherein at least one of the following is true:
a. said frame plates [120] are fenestrated for the attachment of additional accessories;
b. at least one of said plurality of hinges [140] is a dual axis rotating hinge;
c. at least one of said hinges [140] is a double action hinge;
d. said bedding member [130] comprises of at least one fabric strap or mesh;
e. said bedding member [130] is configured for reversible removal from said two opposing longitudinal frames [110]; and
f. said bedding member [130] comprises at least four rigid platform members [610].

6. The collapsible stretcher [100] according to claim 5, wherein said platform members [610] are fenestrated for the attachment of additional accessories.

7. The collapsible stretcher [100] according to claim 5, wherein said platform members [610] are connected to said longitudinal frame [110] by flexible connectors [620] or by said hinges [140], configured to allow said longitudinal frame [110] to be rotated towards and away from said platform members [610].

8. The collapsible stretcher [100] according to claim 5, wherein the number of the platform members [610] is same as the number of the frame plates [120].

9. The collapsible stretcher [100] according to claim 5, wherein said platform members [610] are made of a material selected from the group consisting of: metal, polymeric material, composite material, wood and any combination thereof.

10. The collapsible stretcher [100] according to claim 5, wherein said platform members [610] have a shape selected from a group consisting of a grate-like, a honeycomb-like, a perforated shape and any combination thereof.

11. The collapsible stretcher [100] according to claim 5, wherein said stretcher [100] is configured to be used as a footbridge or a ladder pallet.

12. The collapsible stretcher [100] according to claim 1, wherein at least one of the following is true:
a. said stretcher [100] in said folded position is configured to be transported on- and by-a user, in a vehicle's compartment and/or for storage;
b. said stretcher [100] further comprises of back splint or straps, for securing said load to said stretcher [100];
c. said load is selected from a group consisting of: a patient, an individual of limited capability, an disabled person, an injured person, a victim of an emergency situation, an animal, an unanimated object and any combination thereof;
d. said frame plates [120] are made of a material selected from a group consisting of: metal, polymeric material, composite material, wood and any combination thereof;
e. said stretcher [100] is configured to be used as a bed; and
f. said stretcher [100] weighs less than 4 Kg.

13. The collapsible stretcher [100] according to claim 5, wherein said stretcher [100] is further configured to be attached to an item selected from a group consisting of: wheels, at least one sled, emergency medical intervene means, and any combination thereof.

14. The collapsible stretcher [100] according to claim 1, wherein said stretcher [100] further comprises connectors for attaching at least two of said stretchers [100] in parallel- or in sequential-series configuration.

15. The collapsible stretcher [100] according to claim 1, wherein said stretcher [100] further comprises connectors for attaching electric and electronic equipment said stretcher [100] further comprises connectors for attaching carrying extension cables or ropes.

16. The collapsible stretcher [100] according to claim 1, wherein said stretcher [100] further comprises fixation elements configured to fix said load to said stretcher [100] by means of tying.

17. The collapsible stretcher [100] according to claim 1, wherein said stretcher [100] is made of material at least partially transparent to X-rays and electro-magnetic fields.

18. The collapsible stretcher [100] according to claim 5, wherein said stretcher [100] further comprises a live saving kit [630].

19. The collapsible stretcher [100] according to claim 18, wherein said live saving kit [630] comprises an item selected from a group consisting of: tourniquet means, needles, sutures, bandages, vital monitoring devices, intravenous therapy means, telescopic rod for fixating intravenous means, endotracheal-tube, tracheostomy means and any combination thereof.

20. The collapsible stretcher [100] according to claim 5, wherein said stretcher further comprises a transmitter [640] for transmitting a patient's vitals and status.

21-73. (canceled)
